(19) United States
(12) Patent Application Publication
(10) Pub. No.: US 2025/0236722 A1
(43) Pub. Date: Jul. 24, 2025

(54) SUGAR BEET PECTIN

(71) Applicant: COÖPERATIE KONINKLIJKE COSUN U.A., Breda (NL)

(72) Inventors: Elena Riha-Miloskovska, Dinteloord (NL); Rob Vreeker, Dinteloord (NL); Diana Klaassen-Heshof, Dinteloord (NL); Behzad Rashidi, Dinteloord (NL)

(73) Assignee: COÖPERATIE KONINKLIJKE COSUN U.A., Breda (NL)

(21) Appl. No.: 18/697,744

(22) PCT Filed: Oct. 13, 2022
(86) PCT No.: PCT/EP2022/078515

§ 371 Date: Apr. 2, 2024

(30) Foreign Application Priority Data
Oct. 15, 2021 (EP) 21202852.6

(51) Int. Cl. C08L 5/06; C08B 37/00

(52) U.S. Cl. CPC C08L 5/06; C08B 37/0048

(57) ABSTRACT

The invention pertains to a sugar beet pectin comprising at least 12 wt % protein, based on the total weight of the sugar beet pectin.

The present invention relates to sugar beet pectin.

Sugar beet pectin is derived from sugar beet pulp. This pectin differs from conventional pectin used as rheology modifier, such as citrus pectin and apple pectin, not only chemically and structurally but also functionally. Sugar beet pectin generally has a higher protein content and higher degree of acetylation than conventional pectin and further contain side chains (also referred to as hairy regions). Various authors have reported the composition of the sugar beet pectin, e.g. Pacheco et al (2019; doi:10.3390/molecules24030392), Zhou et al (2021; doi:10.3390/molecules26092829), Chen et al (2018; doi:10.1080/01932691.2016.1151360) and Williams et al (2005; doi:10.1021/jf0404142). Ngouemazong et al (2015; doi:10.1111/1541-4337.12160) provides a review on sugar beet pectin, its structural elements and describes the influence of these structural elements on the emulsifying properties of the sugar beet pectin. Many researchers have altered the structural elements of the sugar beet pectin, for example by demethylation, deacetylation, protein removal, ferulic acid removal and by selective saccharide removal. Protein removal from the sugar beet pectin was reported to be detrimental to the emulsification properties of the sugar beet pectin. Protein levels in sugar beet pectin range from 1 to about 10 wt % (weight %).

The objective of the present invention is to provide a novel sugar beet pectin.

The invention pertains to a sugar beet pectin comprising at least 12 wt % protein, based on the total weight of the sugar beet pectin. The sugar beet pectin of the invention has a higher protein content than conventional sugar beet pectin. The pectin has good emulsifying properties. These emulsifying properties are stronger than conventional bio-based emulsifiers (like gum Arabic) and sugar beet pectin having a lower protein content. The inventors have found that emulsions can be prepared with about 60 wt % of oil, e.g. sun flower oil, with only 0.8 wt % of sugar beet pectin. In addition, emulsions prepared with the inventive sugar beet pectin generally have a good stability and an improved storage stability. A further advantage is that the inventive pectin is capable of capturing monovalent, divalent and/or polyvalent cations, which renders the pectin suitable as sequestering agent. Moreover, the inventive pectin is tolerant to cations such as sodium and calcium ions, and consequently the emulsifying strength does not diminish upon exposure to such cations. In addition, the inventive pectin maintains this strength at a wide pH range, e.g. at pH of 3 a stable emulsion can be prepared. This renders the inventive pectin suitable for use in a wide variety of applications, where the pH or the presence of ions may otherwise be detrimental to the emulsification strength of conventional emulsifiers, such as polyacrylates. The sugar beet pectin of the invention can also be used as a film forming agent, or to improve the wettability.

The inventive pectin is non-toxic and readily biodegradable. Hence, the inventive pectin can be used in food and feed applications. The sugar beet pectin of the invention may replace at least partially or even completely natural emulsifiers such as gum Arabic or synthetic polymeric emulsifiers such as polyacrylate. In replacing gun Arabic moreover lower amounts can be used. In replacing synthetic polymeric emulsifiers, these polymeric emulsifiers generally are synthesized from fossil fuel-derived monomers, which is generally undesirable; the sugar beet pectin provides a natural source and is a greener, more eco-friendly solution. Another advantage of the inventive sugar beet pectin is that the pectin is extracted from an existing side stream, and that no additional sugar beet needs to be grown.

The protein or proteinaceous material in the sugar beet pectin is a structural part of the pectin and is connected to the pectin backbone. Various methods have been described in literature to determine the protein content. For the purposes of this application, the Kjeldahl method is used to determine the nitrogen content, which is then converted to protein content. The Kjeldahl is well established and well known to the person skilled in the art. In this application the Kjeldahl method is performed by hydrolyzing a sample using H₂SO₄ at 420° C. for 2 hours, during which the proteins will be converted to ammonia. The generated ammonia is distilled off and the amount of nitrogen is measured by titration. The amount of protein is calculated by multiplying the nitrogen content by the conversion factor of 6.25 (nitrogen to protein factor).

The sugar beet pectin of the present invention comprises at least 12 wt % protein, based on the total weight of the sugar beet pectin. Preferably, the pectin comprises at least 13 wt % protein, more preferably at least 14 wt % protein, even more preferably at least 15 wt %, even more preferably at least 16 wt % protein and most preferably at least 17 wt % protein, and preferably at most 30 wt % protein, more preferably at most 25 wt % protein, even more preferably at most 22 wt % protein, and most preferably at most 20 wt % protein, based on the total weight of the sugar beet pectin.

In one embodiment, the sugar beet pectin of the present invention comprises at less than 2 wt % insoluble fiber, based on the total weight of the sugar beet pectin. Preferably, the pectin comprises at most 1.5 wt % insoluble fiber, more preferably at most 1.2 wt % insoluble fiber, and most preferably at most 1 wt % insoluble fiber, and preferably at least 0.001 wt % insoluble fiber, more preferably at least 0.01 wt % insoluble fiber, even more preferably at least 0.05 wt % insoluble fiber, and most preferably at least 0.1 wt % insoluble fiber, based on the total weight of the sugar beet pectin. The insoluble fiber can be determined using conventional analytical techniques. An example of such a technique is the ICUMSA GS2-19 method.

In one embodiment of the invention, the sugar beet pectin has a peak molecular weight of at most 100 kDa. Preferably, the peak molecular weight is at most 75 kDa, more preferably at most 50 kDa, and most preferably at most 40 kDa, and preferably at least 1 kDa, more preferably at least 5 kDa, and most preferably at least 10 kDa. Depending on conditions chosen for the process for preparing the inventive pectin, in particular when conditions are chosen for (optimal) acid hydrolysis, the pectin may be partially hydrolyzed, leading to shorter chains of the pectin, in particular the polysaccharide backbone may become shorter and/or the “hairy” side chains may be affected. Sugar beet pectin having a lower peak molecular weight show an improved emulsifying strength. The peak molecular weight can be determined using conventional analytical techniques, e.g. based on size exclusion chromatography. A preferred method is a method based on Phenomenex POLYSEP.

In another embodiment, the inventive pectin comprises at most 3 wt % monosaccharide and/or disaccharides, based on the total weight of the sugar beet pectin. Preferably, the pectin comprises at most 2.5 wt % mono- and/or disaccharides, more preferably at most 2 wt % mono- and/or disaccharides and most preferably at most 1.5 wt % mono- and/or disaccharides, and preferably at least 0.001 wt % mono- and/or disaccharides, more preferably at least 0.01 wt % mono- and/or disaccharides and most preferably at least 0.1 wt % mono- and/or disaccharides, based on the total weight of the sugar beet pectin. The amount of mono- and/or disaccharide can be determined with methods known in the art. Examples of such methods include refractometry, specific gravity and infrared absorption techniques.

In one embodiment, the sugar beet pectin comprises at least 5 wt % arabinose, based on the total weigh of the sugar beet pectin. Preferably, the pectin comprises at least 7 wt % arabinose, more preferably at least 8 wt % arabinose and most preferably at least 10 wt % arabinose, and preferably at most 20 wt % arabinose, more preferably at most 17 wt % arabinose and most preferably at most 15 wt % arabinose, based on the total weight of the sugar beet pectin. The arabinose is generally comprised in the sugar beet pectin as part of the pectin backbone and side chains. The skilled person will understand how to determine the arabinose content. One such method is by enzymatic hydrolysis of the sugar beet pectin into its sugars, e.g. using pectinase and determining the amount of arabinose using chromatography (such as HPLC).

The invention pertains to both modified and unmodified sugar beet pectin. Modified pectin refer to sugar beet pectin that have been modified chemically. Examples of such modifications include demethylation, deacetylation and selective hydrolysis, e.g. to decrease the arabinose content. Such modifications can be performed using known techniques including the use of enzymes, chemicals, heat, ultrasonic and electromagnetic waves.

In one embodiment, the sugar beet pectin is at least partially deacetylated. Preferably, at least 10% of the acetyl substituents is removed, more preferably at least 20%, even more preferably at least 50% and most preferably all the acetyl substituents are removed. Alternatively or additionally, the degree of acetylation is at most 30%, preferably at most 25%, more preferably at most 20% and most preferably at most 15%, and preferably at least 1%, more preferably at least 2% and most preferably at least 5%. In one embodiment of the invention, the degree of acetylation is 0%. The degree of acetylation can be measured using methods well known in the art. One such method uses sodium hydroxide to saponify the sugar beet pectin, and the amount of acetic acid is determined using ion exchange chromatography. The degree of acetylation may influence the hydrophobic nature of the sugar beet pectin. A low(er) degree of acetylation generally is less hydrophobic, which can be advantageous in applications where this hydrophobicity may hamper the functionality of the sugar beet pectin, such as in detergent compositions. Moreover, a lower degree of acetylation may improve the tolerance to cations like calcium and additionally may improve the sequestering capacity. A higher degree of acetylation renders the sugar beet pectin more hydrophobic, which may provide a better balance between hydrophobic and hydrophilic regions for other applications such as leather tanning and (automated) dishwasher compositions.

In one embodiment, the sugar beet pectin is at least partially demethylated. Preferably, at least 10% of the methyl substituents is removed, more preferably at least 20%, even more preferably at least 50% and most preferably all the methyl substituents are removed. Alternatively or additionally, the degree of methylation is at most 50%, preferably at most 40%, more preferably at most 30 mol % and most preferably at most 20%, and preferably at least 1%, more preferably at least 2% and most preferably at least 5%. In one embodiment of the invention, the degree of methylation is 0%. The degree of methylation can be measured using methods well known in the art. One such method uses sodium hydroxide to saponify the sugar beet pectin, and the amount of methanol is determined using ion exchange chromatography. An advantage of a lower degree of methylation is the increased cation tolerance, in particular tolerance to calcium ions, and simultaneously increased sequestering capacity. It is believed that the presence of side chains, the proteinaceous material and/or the acetyl groups hinder two pectin chains to be connected by calcium ions; the lack of these bridges render the sugar beet to have sequestering properties without formation of a gel.

In one embodiment, the sugar beet pectin is at least partially de-arabinoxylated, i.e. arabinose content in the sugar beet pectin of the invention is reduced, e.g. by selective hydrolysis. In one embodiment, the sugar beet pectin comprises at most 10 wt % arabinose, based on the total weigh of the sugar beet pectin. Preferably, the pectin comprises at most 7 wt % arabinose, more preferably at least 5 wt % arabinose and most preferably at least 2 wt % arabinose, and preferably at most 0.001 wt % arabinose, more preferably at most 0.01 wt % arabinose and most preferably at most 0.1 wt % arabinose, based on the total weight of the sugar beet pectin.

The sugar beet pectin of the invention can be in any form known in the art. The sugar beet pectin may be liquid or may be solid. When liquid, solvents can be added to dissolve or disperse the sugar beet pectin. Any solvent in the prior art suitable for dissolving or dispersing the sugar beet pectin of the invention may be used. Preferably, the solvent is a food-grade solvent, such as water, ethanol propylene glycol or combinations thereof. The preferred solvent is water. When in solid form, the sugar beet pectin may be in powder form or in the form of larger particles.

The invention further pertains to a particle comprising the sugar beet pectin in accordance with the invention. It was found that particles of the inventive sugar beet pectin can be easily prepared using conventional drying methods including spray drying and fluidized bed drying techniques. In one embodiment, the particles are spherical, i.e. have a spherical or near spherical shape. The particles of the invention are generally free flowing, resulting in a better processability of the sugar beet pectin. Also the storage stability of the sugar beet pectin is improved. Moreover, such particles may take up some water upon storage (up to 15 wt %) but will remain free flowing and the appearance of these particles will not change. Generally, no preservatives need to be added for good storage stability. Moreover, the water activity of the particles is so low (below 0.6) that no microbial growth is observed upon storage.

In one embodiment, the particle predominantly comprises the sugar beet pectin of the invention. Preferably, the particle comprises at least 50 wt % of sugar beet pectin of the invention, more preferably at least 60 wt %, even more preferably at least 70 wt % and most preferably at least 80 wt %, and preferably at most 99 wt %, more preferably at most 97 wt % and most preferably at most 95 wt %, based on the total weight of the particle.

In a further embodiment, the particle comprises at most 15 wt % water. Preferably, the particle comprises at most 12 wt % of water, more preferably at most 10 wt %, even more preferably at most 8 wt % and most preferably at least 5 wt %, and preferably at least 0.001 wt %, more preferably at least 0.01 wt % and most preferably at least 0.1 wt %, based on the total weight of the particle.

In one embodiment, the particle has a d50 value of at most 1,000 μm. Preferably, the particle has a d50 value of at most 800 μm, more preferably a d50 value of at most 600 μm, and most preferably a d50 value of at most 500 μm, and preferably a d50 value of at least 50 μm, more preferably at least 100 μm and most preferably at least 200 μm.

The remaining part of the particle may be comprised of other components commonly used in particles comprising sugar beet pectin, such as excipients like preservatives, pigments or dyes, etc. With the sugar beet pectin, water, the other components add up to 100 wt % of the total weight of the particle.

The invention further pertains to an emulsion comprising water, oil and the sugar beet pectin according to the invention. The emulsion can be any emulsion known in the art. The emulsion of the invention comprises at least two liquids and can be an oil-in-water emulsion. Preferably, the emulsion is an oil-in-water emulsion. The inventive pectin generally emulsifies and stabilizes the oil droplets in the water matrix. Without being bound by theory, it is believed that the sugar beet pectin is amphiphilic and due to its pectin backbone and proteinaceous portion is sterically dynamic, allowing the pectin to act as an excellent emulsifier; the protein portion predominantly determines the emulsification strength of the pectin and the pectin portion stabilizes the emulsion. The amount of pectin, and in particular the corresponding amount of protein, is generally lower than conventional bio-based protein-containing emulsifiers (such as gum Arabic). Also the amount of oil (or water) used can be high (e.g. above 50 wt % oil in the emulsion). Due to the pH stability of the pectin, emulsions can be prepared at different pH values, including emulsions where lowering to a low pH (e.g. below a pH of 5) and subsequent increase of pH (above 6). As the inventive pectin is bio-based, non-toxic and biodegradable, the inventive sugar beet pectin can be used in food-grade applications, such as dressings, sauces and mayonnaise.

The oil suitable in the emulsion of the invention is any oil or hydrophobic liquid known in the art. Examples of such oils include hydrocarbon oils such as mineral oil fractions comprising linear mineral oils (n-paraffins), branched mineral oils (iso-paraffinic) and/or cyclic mineral oils (naphthenic oils); polyisobutylenes (PIB), phosphate esters such as trioctyl phosphate; polyalkylbenzens such as heavy alkylates, dodecyl benzene and other alkylarenes; esters of aliphatic monocarboxylic acids; linear or branched mono unsaturated hydrocarbons such as linear or branched alkanes containing 8 to 25 carbon atoms and linear or branched alkenes containing 8 to 25 carbon atoms; natural flavor and/or fragrance oils such as essential oils, jojoba oil and flavor oils derived from citrus peel; and natural oils such as palm oil, soybean oil, olive oil, sunflower oil, rapeseed oil and castor oil.

In one embodiment of an oil-in-water emulsion, the emulsion may comprise the oil in an amount of at most 70% by weight (wt %), based on the total weight of the emulsion. Preferably, the oil is present in an amount of at most 60 wt %, more preferably at most 50 wt %, even more preferably at most 40 wt % and most preferably at most 30 wt %, and preferably at least 1 wt %, more preferably at least 2 wt %, even more preferably at least 5 wt % and most preferably at least 10 wt %, based on the total weight of the emulsion.

In one embodiment of an oil-in-water emulsion, the emulsion may comprise water in an amount of at least 30% by weight (wt %), based on the total weight of the emulsion. Preferably, water is present in an amount of at least 40 wt %, more preferably at least 50 wt %, even more preferably at least 60 wt % and most preferably at least 70 wt %, and preferably at most 99 wt %, more preferably at most 98 wt %, even more preferably at most 95 wt % and most preferably at most 90 wt %, based on the total weight of the emulsion.

The sugar beet pectin of the invention can be chosen according to need in amounts as desired. The emulsion of the invention, preferably the oil-in-water emulsion, may comprise the sugar beet pectin in an amount of at most 10% by weight (wt %), based on the total weight of the emulsion. Preferably, the sugar beet pectin is present in an amount of at most 8 wt %, more preferably at most 5 wt %, even more preferably at most 2 wt % and most preferably at most 1 wt %, and preferably at least 0.01 wt %, more preferably at least 0.05 wt %, even more preferably at least 0.1 wt % and most preferably at least 0.2 wt %, based on the total weight of the emulsion.

The remaining part of the emulsion may be comprised of other components commonly used in emulsions such as salts, preservatives, pigments and dyes, fragrances or flavoring agents, etc. With the oil, water and the sugar beet pectin the other components add up to 100 wt % of the total weight of the emulsion.

The emulsions of the invention can be used in food application, paints, construction applications, textiles e.g. fiber treatment, leather lubrication, household care compositions, softening, fabric care in laundry applications, healthcare applications, release agents, water-based coatings and personal care or cosmetic applications. The cosmetic applications include those that are intended to be placed in contact with portions of the human body (skin, hair, nails, mucosa, etc.) or with teeth and the mucous membranes of the oral cavity with a view exclusively or mainly to cleaning them, perfuming them, changing their appearance, protecting them, keeping them in good condition or modifying odors, and skin care, sun care, hair care or nail care applications. Consequently, the present invention further pertains to emulsions of the invention, in particular oil-in-water emulsions, for use in creams, ointments, unguents, gels, pastes, liniments, foams, transdermal patches, lotions and topical solutions.

The invention further pertains to a dispersion comprising the sugar beet pectin of the invention, a solvent, and solid particles. The sugar beet pectin serves as a dispersant enabling solid particles to remain in the solvent rather than settling on the bottom. The inventors found that the inventive sugar beet pectin can form and stabilize dispersions of solids, in particular inorganic solid particles.

The solid particles or solids may be any solid particle known in the art and which can be suitably used in dispersions. The solid particles of the invention may be selected from polymeric particles, oxide and/or hydroxide particles, pigments and fillers.

Examples of polymeric particles include polyolefins such as polystyrene, polyethylene and polypropylene; polyesters such as polyacrylate and polymethyl methacrylate. Further examples of monomers of suitable polymers have been described above.

Examples of oxides and/or hydroxides particles include oxides and hydroxides of aluminum, silicium, boron, sodium, potassium, calcium, iron, nickel, cobalt, titanium, zirconium, cerium, chromium, zinc, tin and tungsten. Preferably, the oxide and/or hydroxides particles are oxides and/or hydroxides selected from aluminum, silicium, calcium, titanium and iron.

Examples of pigments include metal-based pigments, inorganic pigments and biological and organic pigments. Examples of metal-based pigments include cadmium pigments such as cadmium yellow cadmium green, cadmium orange, cadmium sulfoselenide and cadmium red; cobalt pigments such as cobalt violet, cobalt blue, aureolin and cerulean blue; chromium pigments such as chrome yellow and chrome green (viridian); copper pigments such as azurite, Han purple, Han blue and Egyptian blue; iron oxide pigments such as sanguine, caput mortuum, red ochre, Venetian red and Prussian blue; lead pigments such as lead white, Naples yellow, red lead and lead-tin-yellow; manganese pigments such as manganese violet and YInMn blue; mercury pigments such as vermillion; titanium pigments such as titanium yellow, titanium beige, titanium white and titanium black; and zinc pigments such zinc white, zinc ferrite and zinc yellow. Examples of (non-metal-based) inorganic pigments include carbon pigments such as carbon black and ivory black and clay earth pigments such as yellow ochre, raw sienna, burnt sienna, raw umber and burnt umber; and ultramarine pigments such as ultramarine and ultramarine green shade. Examples of biological pigments include alizarin, alizarin crimson, gamboge, cochinal red, rose madder, indigo, indian yellow and Tyrian purple. Examples of organic pigments include quinacridone, magenta, phthalo green, phthalo blue, pigment red 170 and diarylide yellow.

Examples of fillers include calcium carbonates such as ground calcium carbonate (GCC) and precipitated calcium carbonate (PCC), kaolin, carbon black, talc, bentonite, hydrotalcite and hydrotalcite-like clays, diatomite, limestone, titanium dioxide, wood flour, saw dust, calcium sulphate, aluminum trihydrate, aluminum silicate and silica.

In one embodiment, the dispersion may comprise the solid particles in an amount of at most 60% by weight (wt %), based on the total weight of the dispersion. Preferably, the solid particles are present in an amount of at most 50 wt %, more preferably at most 40 wt %, even more preferably at most 30 wt % and most preferably at most 25 wt %, and preferably at least 1 wt %, more preferably at least 2 wt %, even more preferably at least 5 wt % and most preferably at least 10 wt %, based on the total weight of the composition.

In one embodiment of the invention, the solid particles have a d90 value of at most 100 μm, preferably at most 50 μm, more preferably at most 20 m, even more preferably at most 10 m, even more preferably at most 5 μm, and most preferably at most 1 μm, and at least 10 nm, preferably at least 20 nm, more preferably at least 50 nm and most preferably at least 100 nm.

In one embodiment of the invention, the solid particles have a d99 value of at most 100 μm, preferably at most 50 μm, more preferably at most 20 μm, even more preferably at most 10 μm, even more preferably at most 5 μm, and most preferably at most 1 μm, and at least 10 nm, preferably at least 20 nm, more preferably at least 50 nm and most preferably at least 100 nm.

The dispersion of the invention further comprises a solvent. The solvent can be any solvent known in the art and suitable for use in dispersions. Examples of solvents include water; alcohols such as ethanol and isopropanol; alkanes such as pentane and hexane; ketones such as methyl ethyl ketone (MEK), acetone and methyl propyl ketone; and aromatic solvents such as toluene and benzene. In a preferred embodiment, the dispersion comprises water as solvent. Especially, the solvents other than water increase the amount of volatile organic compounds (VOC). Therefore, dispersions of the invention are preferred that only comprise water as solvent.

In one embodiment, the dispersion may comprise water (or a solvent) in an amount of at most 90% by weight (wt %), based on the total weight of the dispersion. Preferably, water is present in an amount of at most 80 wt %, more preferably at most 70 wt %, even more preferably at most 60 wt % and most preferably at most 50 wt %, and preferably at least 1 wt %, more preferably at least 2 wt %, even more preferably at least 5 wt % and most preferably at least 10 wt %, based on the total weight of the dispersion.

The remaining part of the dispersion may be comprised of other components commonly used in dispersions. With the solid particles, the solvent or water and the sugar beet pectin, the other components add up to 100 wt % of the total weight of the dispersion.

The invention further pertains to a method for treating leather comprising the step of contacting leather with an aqueous phase comprising the sugar beet pectin of the invention. Preferably, the leather is tanned leather. The invention further pertains to leather comprising the sugar beet pectin of the invention, preferably leather impregnated with the sugar beet pectin of the invention. The high protein content of the inventive pectin is advantageous and provides improved organoleptic properties of the leather or tanned leather. Further details of the leather treatment process, the aqueous phase and the impregnated leather can be found in WO 2019/185824, which is included in the application by reference.

The invention further pertains to a water softener or detergent composition comprising the sugar beet pectin of the invention. Preferably, the water softener or detergent composition further comprises an effervescent agent. The sugar beet pectin of the invention is capable of stabilizing the detergent or water softener tablets or particles. When an effervescent agent is present, the disintegration of the tablet or particles is good while increasing the hardness of the tablet or particles. The inventive sugar beet pectin can replace at least partially or completely the use of synthetic polymers commonly used in water softener or detergent compositions, such as polyacrylates. Further details of the water softener or detergent composition and their properties and use can be found in WO 2016/87639, which is included in the application by reference.

The invention further pertains to a process for preparing a sugar beet pectin according to the invention comprising the steps of:
(a) bringing a pectin-rich suspension derived from sugar beet pulp to a pH below 4 and a temperature above 80° C.;
(b) centrifuging the pectin-rich suspension at a temperature between 20° C. and 80° C. to separate the solids from the supernatant;
(c) subjecting the supernatant to a membrane filtration, preferably ultrafiltration, with a MWCO of at most 50 kDa to separate at least a portion of small molecules and salts from the supernatant to form a retentate comprising the sugar beet pectin; and
(d) optionally removing water from the retentate.

The pectin-rich suspension provided in step (a) of the process of the invention is derived from sugar beet pulp. Preferably, the sugar beet pulp is exposed to acid extraction and subsequently the solid fibers are separated from the aqueous pectin-rich suspension, e.g. by decanting or filtering. The pectin-rich suspension is maintained at a temperature above 80° C. and the pH of the suspension is brought to below 4. Preferably, the temperature of the suspension is at least 85° C., more preferably at least 90° C., more preferably at least 95° C. and most preferably at most 250° C., and preferably at most 220° C., more preferably at most 200° C., and most preferably at most 180° C. In another preferred embodiment, the pH of the suspension is at most 3.5, more preferably at most 3, and most preferably at most 2.5, and preferably at least 0, more preferably at least 0.5, even more preferably at least 1 and most preferably at least 1.5. It is contemplated that the pulp is first removed from the sugar beet pulp to obtain the pectin-rich suspension before the suspension is exposed to acid extraction as indicated above.

In step (b) of the inventive process, the pectin-rich suspension is centrifuged in order to separate the solids from the supernatant. The supernatant comprises the sugar beet pectin, and the solids generally comprise insoluble fibers. The centrifuging can be performed in any centrifuge known in the art. The centrifuge may be a batch-type centrifuge like a basket centrifuge, a peeler centrifuge and a pusher-peeler centrifuge; or a continuous centrifuge like a conical screen centrifuge or a pusher centrifuge. Preferably, a continuous centrifuge is used in step (b).

In step (c) of the process, the supernatant is subsequently subjected to membrane filtration, in particular ultrafiltration with a MWCO (molecular weight cut off) of at most 50 kDa. Preferably, the MWCO is at most 40 kDa, more preferably at most 35 kDa, even more preferably at most 30 kDa and most preferably at most 25 kDa, and preferably at least 5 kDa, more preferably at least 10 kDa and most preferably at least 15 kDa. Depending on the conditions of ultrafiltration (flow rate, temperature, MWCO and type of membrane), minerals, monosaccharides and/or oligosaccharides are effectively separated from the sugar beet pectin and removed through the permeate. The sugar beet pectin is maintained in the retentate.

In the optional step (d), water may be at least partially removed from the retentate. Water removal can be performed using conventional techniques including membrane separation such as (reverse) osmosis and evaporation techniques such as fluidized bed drying, spray drying and evaporation through heating the retentate. In this way, an aqueous suspension comprising sugar beet pectin can be obtained. When the sugar beet pectin is dried further particles as indicated above can be obtained.

The sugar beet pectin of the invention can be used in a wide range of applications. The invention pertains to the use of the sugar beet pectin in food applications, paints, construction applications, textiles e.g. fiber treatment, leather lubrication, household care compositions, softening, fabric care in laundry applications, healthcare applications, release agents, water-based coatings, personal care or cosmetic applications, emulsion polymerizations, carpeting, automobile parts, window frames, kitchen worktops, container closures, lunch boxes, closures, medical devices, household articles, food containers, dishwashers, outdoor furniture, blow-molded bottles, disposable non-woven fabrics, cables and wires, packaging, coil coating applications, can coatings, car refinish, mining, oil drilling, fuel additive and automotive applications. Each of these uses is separately contemplated and is meant to be explicitly and individually disclosed.

The invention is exemplified in the following Examples.

### EXAMPLES

### Example 1

1 kg of sugar beet pulp is heated to a temperature of 90° C. and brought to a pH of 1.5 using an aqueous HCl solution. The suspension is kept under these conditions for 16 hours. The solids were removed from the resulting suspension using a filter press. The pectin-rich supernatant is subsequently centrifuged with a conical screen centrifuge while maintaining the centrifuge at a temperature of 50° C. The resulting liquid was cooled and led over an ultrafiltration unit with an MWCO of 35 kDa. The permeate was divided into two portions. The first liquid was dried in an oven at 90° C. A dried powder was obtained with a dry matter content of 88 wt %. The sugar beet pectin contained 18.8 wt % protein as measured using the Kjeldahl method (see below). 2.3 wt % of arabinose was found in the sugar beet pectin. The sugar beet pectin exhibits a degree of methylation of 52.0% and a degree of acetylation of 13.8%.

A second portion was dried in a fluidized bed drier to obtain spherical particles with an average particle size of 350 μm. These particles were free flowing.

The spherical particles were kept in a humidity chamber (relative humidity 80%, 20° C.) for three days. The particles contained about 15 wt % water. These particles were free flowing.

### Kjeldahl Method

The Kjeldahl method was performed by hydrolysing a sample using H₂SO₄ at 420° C. for 2 hours, during which the proteins will be converted to ammonia. The generated ammonia is distilled off and the amount of nitrogen is measured by titration. The amount of protein is calculated by multiplying the nitrogen content by the conversion factor of 6.25 (nitrogen to protein factor).

### Arabinose

The arabinose content is determined by enzymatic hydrolysis of the sugar beet pectin into its individual sugars using pectinase and determining the amount of arabinose using HPLC.

### Degree of Methylation and Degree of Acetylation

The degree of acetylation (DA) and the degree of methylation (DM) can be measured using sodium hydroxide to saponify the sugar beet pectin, and the amount of acetic acid (for DA) and methanol (for DM) are determined using ion exchange chromatography.

### Example 2: Mayonnaise

A model mayonnaise comprising the sugar beet pectin powder of Example 1 was prepared with the following composition (in g/100 g):

| | |
|---|---|
| Sugar beet pectin | 0.8 |
| Sunflower oil | 60 |
| NaCl | 1.2 |
| EDTA | 0.008 |
| Acetic acid | add until pH reaches 3.8 |
| Water | make up to 100 gram |

### Preparation of an Aqueous Phase:

disperse the sugar beet pectin powder of Example 1 in demineralized water, stir with magnetic stirrer
raise pH to 6.5 using 1 M NaOH (to dissolve pectin)
add NaCl and ethylenediaminetetraacetic acid (to prevent lipid oxidation)
lower pH to 3.8 with concentrated acetic acid

### Preparation of the Emulsion:

slowly add sunflower oil to aqueous phase while stirring with a high shear mixer (Silverson L5M-A, fine emulsor screen, 3500 rpm)
after all oil is added, continue stirring at 8000 rpm for 4 minutes
store emulsion at 5° C.

The resulting model mayonnaise had a light and smooth appearance with a lower viscosity than conventional mayonnaise. Droplet size of the emulsion was measured using a Malvern Mastersizer. Average droplet diameter (D_{3,2}) is 10.0 μm.

It is noted that the model mayonnaise and any mayonnaise containing sugar beet pectin instead of egg yolk renders the mayonnaise fully plant-based and is suitable for vegan consumers.

### Example 3 and Comparative Example A: Limonene-Containing Emulsions

Sugar beet pectin was used in an emulsion containing limonene (limonene is the major component of citrus fruit peels and used in carbonated beverages). The emulsifying properties of sugar beet pectin (Example 3) were compared to gum Arabic (Comparative Example A).

Composition of the emulsion of Example 3 (in g/100 g):

| | |
|---|---|
| Sugar beet pectin | 1.0 |
| Limonene | 10 |
| HCl | add until pH reaches 4.7 |
| Water | make up to 100 gram |

Composition of emulsion of Comparative Example A (in g/100 g):

| | |
|---|---|
| Gum Arabic | 6.4 |
| Limonene | 10 |
| HCl | add until pH reaches 4.7 |
| Water | make up to 100 gram |

### Emulsification:

The sugar beet pectin powder of Example 1 was dispersed in demi-water. The pH of the sugar beet pectin-containing dispersion was raised to 6.5 using 1 N NaOH (to allow dissolution) and subsequently lowered to pH 4.7 using 0.1 M HCl. Limonene was slowly added to the solution while stirring with a high shear mixer (Silverson L5M-A, fine emulsor screen, 10,000 rpm). The resulting emulsion was subsequently homogenized using a GEA Lab PandaPlus 1000 homogenizer (10 passes, 300 bar).

For gum Arabic, the same procedure was followed except that gum Arabic was used instead of sugar beet pectin in the amount provided above.

Droplet sizes were measured after storing the emulsions for 1 day at 5° C. using a Malvern Mastersizer. Average droplet diameters (D_{3,2}) were 2.16 and 2.69 μm for sugar beet pectin and gum Arabic emulsions, respectively. The results show that limonene-in-water emulsions can be formed at relatively low sugar beet pectin concentrations (1 wt % sugar beet pectin versus 6.4 wt % gum Arabic).

1. A sugar beet pectin comprising at least 12 wt % protein, based on the total weight of the sugar beet pectin.

2. The pectin according to claim 1, wherein the sugar beet pectin comprises at least 15 wt % of protein, based on the total weight of the sugar beet pectin.

3. The pectin according to claim 1, wherein the sugar beet pectin comprises less than 2 wt % of insoluble fiber, based on the total weight of the sugar beet pectin.

4. The pectin according to claim 1, wherein the sugar beet pectin has a peak molecular weight of at most 100 kDa.

5. The pectin according to claim 1, wherein the sugar beet pectin is at least partially deacetylated.

6. The pectin according to claim 1, wherein the sugar beet pectin is at least partially demethylated.

7. The pectin according to claim 1, wherein the sugar beet pectin comprises at most 10 wt % arabinose, based on the total weight of the sugar beet pectin.

8. A process for preparing a sugar beet pectin according to claim 1, comprising the steps of:
a. bringing a pectin-rich suspension derived from sugar beet pulp to a pH below 4 and a temperature above 80° C.;
b. centrifuging the pectin-rich suspension at a temperature between 20° C. and 80° C. to separate the solids from the supernatant;
c. subjecting the supernatant to a membrane filtration, with a MWCO of at most 50 kDa to separate at least a portion of small molecules and salts from the supernatant to form a retentate comprising the sugar beet pectin; and
d. optionally removing water from the retentate.

9. (canceled)

10. A dispersion comprising the sugar beet pectin according to claim 1, a solvent, and solid particles.

11. (canceled)
